(19) United States
(12) Patent Application Publication
(10) Pub. No.: US 2024/0002699 A1
(43) Pub. Date: Jan. 4, 2024

(54) NAIL SEALABLE HOUSE WRAP

(71) Applicant: SHURTAPE TECHNOLOGIES, LLC, Hickory, NC (US)

(72) Inventors: Khaled EL-TAHLAWY, Hickory, NC (US); Ameet KULKARNI, Hickory, NC (US)

(21) Appl. No.: 18/265,072

(22) PCT Filed: Dec. 6, 2021
(86) PCT No.: PCT/US2021/062048

§ 371 Date: Jun. 2, 2023

Related U.S. Application Data
(60) Provisional application No. 63/121,659, filed on Dec. 4, 2020.

(51) Int. Cl. C09J 7/29; B32B 5/02; B32B 5/24; B32B 5/18; C09J 7/21; E04B 1/62; E04D 12/00

(52) U.S. Cl. CPC C09J 7/29; B32B 5/022; B32B 5/245; B32B 5/18; C09J 7/21; E04B 1/625; E04D 12/002; B32B 2307/73; B32B 2260/021; B32B 2260/046; B32B 2307/7246; B32B 2262/0284; B32B 2266/0207; B32B 2307/5825; B32B 2307/54; B32B 2419/00; C09J 2203/346; C09J 2400/263; C09J 2400/243; C09J 2433/00

(57) ABSTRACT

A multi-layer laminate exterior finishing system. The system is a composite having a non-woven film layer; a hydrophobic layer; and an adhesive layer.

### BACKGROUND

The present exemplary embodiment relates to a vapor permeable, substantially liquid impermeable composite sheet material. It finds particular application in conjunction with sealing surfaces of buildings and will be described with particular reference thereto. However, it is to be appreciated that the present exemplary embodiment is also amenable to other similar applications.

Modern building structures often make use of barrier membrane sheet materials to control the flow of moisture in and out of a building and also to control the ventilation or movement of air through a wall or roof structure. Typical membrane products are designed to be weather resistant, keeping out liquid water and resisting wind pressure.

Sheet materials are widely available for wrapping the exterior surfaces of buildings prior to the attachment of siding materials. Housewraps, as they are often called in the trade, restrict the passage of rain-water and air from entering the interior of a building, but permit water vapor to escape and help to contain “conditioned” air in the interior of the structure.

Some housewraps that are currently in the marketplace include TYVEK®, a high density polyethylene spun-bonded sheet material from DuPont Company, Wilmington, Del., TYPAR, a spun-bonded polypropylene fiber mat material from Berry Global Inc., Old Hickory, Tenn., and RUFCO-WRAP, a microperforated polyethylene sheet material sold by Raven Industries, Inc., Sioux Falls, S.D. The nonwoven fabric blocks water, but allows water vapor to pass therethrough. It is beneficial for such moisture-vapor permeable waterproofing sheets to pass ASTM D-1970/D-1970M-13 or similar modified tests such as Modified Test 1 of ASTM D-1970/D-1970M-13, Modified Test 2 of ASTM D-1970/D-1970M-13, or Modified Test 3 of ASTM D-1970/D-1970M-13.

Typical membrane sheeting is attached to a wall or roof structure by means of mechanical fasteners such screws or nails or by use of an adhesive. Adhesive can be a preferred mechanism because it eliminates the need to make physical holes in the membrane sheet material. Adhesive however is often not vapor permeable and therefore must be applied discontinuously which creates complexities for installation. The present disclosure is directed to a housewrap sheet material having an at least substantially continuous coating of adhesive on a major surface of the sheet material and demonstrating a commercially acceptable vapor permeability.

### BRIEF DESCRIPTION

Various details of the present disclosure are hereinafter summarized to provide a basic understanding. This summary is not an extensive overview of the disclosure and is neither intended to identify certain elements of the disclosure, nor to delineate scope thereof. Rather, the primary purpose of this summary is to present some concepts of the disclosure in a simplified form prior to the more detailed description that is presented hereinafter.

According to a first embodiment, a multi-layer laminate exterior finishing system is provided. The system is a composite having a non-woven film layer; a hydrophobic polymer layer; and an adhesive layer.

According to a further embodiment, a multi-layer laminate exterior finishing system is provided. The system includes a saturated fibrous non-woven layer and an adhesive layer.

According to another embodiment a self-wound multi-layer laminate exterior finishing system is provided. The system includes a non-woven layer, one of a release coating or a polymer including a hydrophobic additive coating, and an adhesive layer. The system has a water vapor permeability according to ASTM E96B of at least 20 perm and passes the nail sealability test of ASTM D1970.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a sectional view of a representative barrier laminate; and

FIG. 2 is a fragmentary view of a building housing the barrier laminate of FIG. 1 applied thereto.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used herein, the terms “about”, “generally” and “substantially” are intended to encompass structural or numerical modifications which do not significantly affect the purpose of the element or number modified by such term.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include thermoplastics, thermosetting resins and all possible geometrical configurations of their molecules.

As used herein, the term “multilayer laminate” means a laminate having multiple layers which are of the same or different constructions. Such a laminate may be made, for example, of a non-woven film, a hydrophobic polymeric foam layer and an adhesive layer.

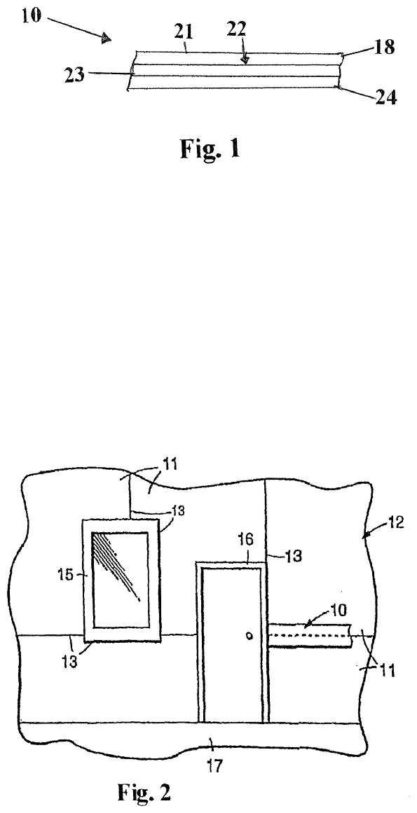

Referring now to FIGS. 1 and 2 a first embodiment of a multi-layer barrier laminate is designated by the reference numeral 10. The barrier laminate 10 is adapted for attachment to the outer surface of a structure, such as a house 12 illustrated. The sheathing 11 is attached prior to attachment of siding to cover joints 13 between structural members and between adjacent sheathing members 11, window frame 15, door frame 16, sill 17, corners, cantilevers, raised heel trusses and band joists, etc. assembled to form the structure or house 12. Although a house sidewall is depicted in FIG. 2, the subject flexible barrier underlayment is equally suitable for use with roofs and commercial buildings.

The barrier laminate 10 comprises a flexible polymer layer 18 having opposite first and second major surfaces 21 and 22. The polymer layer 18 can have minute passageways between its major surfaces 21 and 22 affording passage of water vapor between its major surfaces while restricting the passage of liquid water and air between its major surfaces 21 and 22.

Polymers suitable for use as the polymer layer include acrylates, cellulose acetate, epoxy resins, styrene/polyester resins, phenolic resins, polyethylene, polystyrene, silicones, urea-formaldehyde resins, polyurethanes, latex foam rubbers, natural rubber, synthetic-elastomers, poly (vinyl chloride), ebonite, and polytetrafluoroethylene. An exemplary polymer is an acrylic, such as the hydrophobic acrylate sold by Omnova, A Synthomer Business, as Omnapel 3158 or a carboxylated styrene butadiene latex also sold by Omnova as Genflo, or a styrene-acrylic polymer dispersion such as Erconova sold by Mallard Creek Polymers.

In some embodiments, the polymeric layer is comprised of a hydrophobic polymer material including a hydrophilic additive. Exemplary hydrophilic materials include polyethylene glycol, polyvinyl alcohol, polyvinylpyrrolidone, polysaccharides and polyglutamic acid. The hydrophilic material can be present in the foamed hydrophobic polymer material in an amount between 0.1 and 5 wt. % or between 0.25 and 3.0 wt. %.

Advantageously, the hydrophobic polymer material can function as a water barrier while the hydrophilic additive provides vapor permeability.

The barrier laminate 10 also includes a non-woven film 23 and a layer 24 of continuous pressure sensitive adhesive for adhering the barrier layer 10 to structural members. The barrier laminate may include a removable release paper to allow long strips of the laminate to be rolled.

The non-woven material can be a breathable film or one or several layers having a structure of individual fibers or threads which may be interlaid but might not be in an identifiable manner as in a knitted fabric. Nonwoven fabrics or webs have been formed from many processes such as for example, melt blowing processes, spun bonding processes, ultrasonic bonding processes, thermal point bonding processes, and bonded carded web processes. Two exemplary non-woven film materials suitable for the present multi-layer laminate exterior finishing system are Powerlon UltraPerm Air Barrier available from Industrial Textiles & Plastics Ltd. of York, United Kingdom and FLX17/FLX20/FLX57 available from Feliks Plastic of Eskisehir, Turkey. The composite sheet material of the present invention preferably includes a breathable film.

In certain embodiments, it may be desirable for the nonwoven film to be highly calendared. More particularly, a highly calendared non-woven film can have a consistent 7 to 13 mils thickness and the weight range of 80-200 gsm. As used herein the phrase “highly calendared” is intended to reflect that the non-woven film thickness does not vary outside the stated range.

In certain embodiments, it may be desirable to treat the non-woven material with a saturant, such as styrene acrylic polymer, styrene butadiene rubber, ethylene vinyl acetate polymer, acrylic polymer, nitrile rubber, polytetrafluoroethylene, ethylene propylene diene monomer rubber, polyvinylidene fluoride, etc. The saturant advantageously helps the laminate to provide acceptable nail sealability and hydrostolic water ponding according to the requirements of ASTM D1970 and AC38. The saturant can be applied using a dip and nip process.

The polymer layer can be for example a foamed polymer material. A foamed or cellular polymer or plastic can be defined as a material wherein the apparent density is decreased substantially by the presence of numerous cells disposed throughout its mass.

Foaming agents suitable for creating the foamed polymer are any of the foaming agents commonly used in the foamed polymer art. Examples of such foaming agents include gas and low boiling liquids as well as chemical foaming agents which are either activated by heat or by a chemical reaction when two or more components are mixed together.

Examples of gaseous and low boiling liquid foaming agents include air, nitrogen, carbon dioxide, the various halocarbons, including fluorocarbons, chlorofluorocarbons, and chlorocarbons, the pentanes, hexanes, acetone, methylethyl ketone and the like.

Examples of multipart foaming agents are metal carbonates and bicarbonates plus acids, such as sodium bicarbonate, sodium carbonate, ammonium stearate and calcium carbonate plus citric acid, sulfamic acid and the like.

Foaming agents are described in detail in “Encyclopedia of Polymer Science and Technology”, Vol. 2, pages 532-565, John Wiley & Sons, Inc., 1965 which is hereby incorporated by reference.

The amount of foaming agent used will vary widely depending on whether it is a gas, a liquid, or a chemical composition which decomposes or reacts to form a gas. The amount of foaming agent to be used is based on the desired density of the foamed composition. The amount should be sufficient to create a breathable layer that remains water resistant.

It is contemplated that the foamed polymer can be applied to the non-woven layer using any means known in the art, such as, extruding die, slot die, reverse roll or knife over roll.

It may be desirable to include a hydrophobic additive in the polymer. For example, paraffin wax, fatty acids (e.g. C14-C22), fatty acid amides, hydrophobic silica, carbodiimide carbamate, polyethylene wax dispersion, or other additives known to the skilled artisan can be included in the polymer layer. In addition, it is contemplated that the hydrophobic additive can function as a release material to allow the barrier laminate to be self-winding.

An exemplary adhesive for use in the present multi-layer laminate is a UV cured acrylic based adhesive of the type disclosed in PCT/US2020/053538, the disclosure of which is herein incorporated by reference.

Generally, to qualify as being “breathable”, the laminate should have a water vapor transmission rate (WVTR) of at least about 250 g/m2 hours.

In forming the laminate, the layers may be coextruded to increase bonding.

The multi-layer laminate is generally light weight, preferably less than 200 grams/m2, and more preferably about 100-200 grams/m2, and can be disposed on building sidewalls or beneath tile roofing material above the roofing sheathing of a building. The substrate can be printed with the brand name of the company producing it, or other graphics, especially when used in billboards, graphics advertising products or services.

### EXAMPLES

Permeable House Wrap 1

Non-Woven: Felix (57 gsm) & ITP (90 gsm)
Adhesive Thickness: 3, 5 and 8 mils
Adhesive Coverage: 100%

TESTING

| Non-Woven | Adhesive mils | Nail Sealability | Permeability |
|---|---|---|---|
| ITP | 3 | 2/2 | 24.5 |
| ITP | 5 | 2/2 | 15.5 |
| ITP | 8 | 2/2 | 12.6 |
| Felix 57 | 3 | 2/2 | 25.4 |
| Felix 57 | 5 | 2/2 | 19.1 |
| Felix 57 | 8 | 2/2 | 13.3 |

Permeable House Wrap 2

Non-Woven: 100 gsm & 120
Omnapel 3158 Top Coating: 1.2 OZ/Y2
Adhesive Thickness: 5 mils
Adhesive Coverage: 0 & 100%

TESTING

| Non-Woven, | | | |
|---|---|---|---|
| gsm | Adhesive mils | Nail Sealability | Permeability |
| 100 | 0 | 0/2 | |
| 100 | 5 | 2/2 | 28 |
| 120 | 0 | 0/2 | |
| 120 | 5 | 2/2 | 29.9 |

Permeable House Wrap 3

Non-Woven: 100 gsm
Saturant: SA 126 (0.5, 1, 1.5 OZ/Y2)
Omnapel 3158 Top Coating: 1.2 OZ/Y2
Adhesive Thickness: 5 mils
Adhesive Coverage: 0 & 100%

TESTING

| Saturant, | Topcoat, | Adhesive | Nail | |
|---|---|---|---|---|
| oz/Y2 | oz/Y2 | Mils | Sealability | Permeability |
| 0.5 | 1.2 | 0 | 2/2 | 18.3 |
| 0.5 | 1.2 | 5 | 2/2 | 19.2 |
| 1 | 1.2 | 0 | 1/2 leak | 19.8 |
| 1.5 | 1.2 | 0 | 2/2 | 19.9 |
| 1.5 | 1.2 | 5 | 2/2 | 12.9 |

PERMEABLE HOUSE WRAP 4

Non-Woven: 100 & 120 gsm PP non-woven
Adhesive Thickness: 3, 5 and 8 mils
Adhesive Coverage: 100%

TESTING

| Non-Woven, | Adhesive | Nail | |
|---|---|---|---|
| gsm | mils | Sealability | Permeability |
| 100 | 3 | Water leak | 50.2 |
| 100 | 5 | Water leak | 43.5 |
| 100 | 8 | Water leak | 34.1 |
| 120 | 3 | Lesser Water | 53.2 |
| | | leak | |
| 120 | 5 | Lesser Water | 36.65 |
| | | leak | |
| 120 | 8 | Lesser Water | 38.8 |
| | | leak | |

Permeable House Wrap 5 - Self - Winding

Highly Calendared PET Non-Woven: 80-200 gsm
Top Coating As Indicated Below:

The PET non-woven was coated with water dispersion polymer as follows:
1) Foaming: air was injected to the polymer dispersion under high mixing speed to form small pores in the coating.
2) The polymer was coated using extruding die or knife over roll.

I) TOP COAT A) Genflo 3600 was blended with 0.3% of Paraffin wax dispersion (e.g. OCTOWAX 321)

| | | Nail | | Perm | |
|---|---|---|---|---|---|
| | Coating | Sealability | | (ASTM E96 | |
| | weight, | (ASTM | Water | water | Peel |
| Release Kind | oz/yd² | D1970) | Ponding | method) | resistant |
| Octawax (0.3%) | 1.1 | Failed | Passed | 3.5 | Passed |
| Octawax (0.3%) | 1.5 | Passed | Passed | 3.4 | Passed |

### Physical Testing:

| | | CD | MD | | |
|---|---|---|---|---|---|
| | Coating | Elmendorf | Elmendorf | | |
| | weight, | Tear | Tear | Tensile | |
| Release Kind | oz/yd² | (g) | (g) | (Lb/in) | Stretch % |
| Octawax (0.3%) | 1.1 | DNT | 1008 | 46.3 | 33 |
| Octawax (0.3%) | 1.5 | DNT | 1352 | 46.4 | 34.6 |

Adhesion Testing: 5 mils of UV curable acrylic adhesive formulation (100% coverage) were coated on the non-woven side.

| | Coating | RT | | 10° F. | 0° F. |
|---|---|---|---|---|---|
| | weight, | Lap Shear, | ATB | ATB | ATB |
| Release Type | oz/yd² | min | (oz/in) | (oz/in) | (oz/in) |
| Octawax (0.3%) | 1.1 | 51.6 | 26.75 | 10.4 | 6.25 |
| Octawax (0.3%) | 1.5 | 7.75 | 24.65 | 10 | 9.4 |

II) TOP COAT B) CR27 vinyl acetate/silicone and vinyl acrylic blend

| | | Nail | | Perm | |
|---|---|---|---|---|---|
| | Coating | Sealability | | (ASTM E96 | |
| | weight, | (ASTM | Water | water | Peel |
| Release Kind | oz/yd² | D1970) | Ponding | method) | resistant |
| CR27 | 1.1 | Failed | Passed | 21.8 | Passed |
| CR27 | 1.5 | Passed | Passed | 23.3 | Passed |

### Physical Testing:

| | | CD | MD | | |
|---|---|---|---|---|---|
| | Coating | Elmendorf | Elmendorf | | |
| | weight, | Tear | Tear | Tensile | |
| Release Kind | oz/yd² | (g) | (g) | (Lb/in) | Stretch % |
| CR27 | 1.1 | 720 | 696 | 56.7 | 27.5 |
| CR27 | 1.5 | 856 | 688 | 52.25 | 24.75 |

Adhesion Testing: 5 mils of UV curable acrylic adhesive formulation (100% coverage) were coated on the non-woven side.

| | Coating | RT | | 10° F. | 0° F. |
|---|---|---|---|---|---|
| | weight, | Lap Shear, | ATB | ATB | ATB |
| Release Type | oz/yd² | min | (oz/in) | (oz/in) | (oz/in) |
| CR27 | 1.1 | 7.05 | 31.75 | 76 | 61 |
| CR27 | 1.5 | 6.7 | 27.8 | 58.85 | 53.65 |

II) TOP COAT C) Ecronova 6620 acrylic polymer was blended with CARBOWAX PEG 1000

| Formulation | 5 | 6 | 7 | 8 |
|---|---|---|---|---|
| Target weight | 1.5 | 1.5 | 1.5 | 1.5 |
| (oz/yd²) | | | | |
| Ecronova 6620 | 200 | 200 | 200 | 200 |
| CARBOWAX PEG | 0 | 0.5 | 1 | 2 |
| 1000 | | | | |
| Thickener (Alkali | 0.5 | 0.5 | 0.5 | 0.5 |
| swellable emulsion) | | | | |

| | | Nail | | Perm | |
|---|---|---|---|---|---|
| Additive % | Coating | Sealability | | (ASTM E96 | |
| (CARBOWAX | weight, | (ASTM | Water | Water | Peel |
| PEG 1000) | oz/yd² | D1970) | Ponding | method) | resistant |
| 0 | 1.5 | Passed | Passed | 17.5 | Passed |
| 0.5 | 1.5 | Passed | Passed | 19.8 | Passed |
| 1 | 1.5 | Passed | Passed | 20.2 | Passed |
| 2 | 1.5 | Passed | Passed | 26.8 | Passed |

Composite barrier strips, patches, layers, wraps and covers, building structures sealed with barrier laminates and processes for preparing barrier laminates and applying them to structures are provided by this disclosure. It is understood that these composite materials can be used for applications outside of the building and construction industry. For example, the breathable water-resistant composites of this invention could have application in the medical, filtration, packaging and garment industry as tape, envelope, packaging, or fabric.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

1. A multi-layer laminate exterior finishing system, comprising:
a non-woven layer;
a hydrophobic polymer layer including a hydrophobic additive selected from paraffin wax, fatty acids, fatty acid amides, hydrophobic silica, carbodiimide carbamate, and polyethylene wax dispersion;
an adhesive layer covering 100% of a surface of the non-woven layer and having a thickness between 3 and 10 mils; and
wherein said finishing system is self-wound.

2. The system of claim 1 wherein the non-woven layer further includes a saturant.

3. The system of claim 2 wherein the saturant is comprised of crossed linked polymer.

4. (canceled)

5. (canceled)

6. (canceled)

7. (canceled)

8. The system of claim 1 having a water vapor permeability according to ASTM E96B of at least 10 perm or at least 20 perm.

9. The system of claim 1 satisfying nail sealability testing of ATSM D1970.

10. The system of claim 1 wherein said adhesive is selected from UV acrylic and solvent acrylic.

11. The system of claim 1 wherein the hydrophobic polymer layer is foamed.

12. The system of claim 1 wherein the hydrophobic polymer layer includes a hydrophilic additive.

13. The system of claim 12 wherein the hydrophilic additive is selected from polyethylene glycol, polyvinyl alcohol, polyvinylpyrrolidene, polysacchariding and poly glutamic acid, and mixtures thereof.

14. (canceled)

15. (canceled)

16. (canceled)

17. (canceled)

18. (canceled)

19. (canceled)

20. (canceled)

21. (canceled)

22. (canceled)
